(19) United States
(12) Patent Application Publication
(10) Pub. No.: US 2009/0065304 A1
(43) Pub. Date: Mar. 12, 2009

(54) Extendable and retractable ladder

(76) Inventor: Shikun JIAN, YANGJIANG CITY (CN)

Correspondence Address: ERIC CHAN, 42 PIN OAKS DRIVE, PHOENIXVILLE, PA, 19460, US

(21) Appl. No.: 11/968,634

(22) Filed: Jan. 2, 2008

(30) Foreign Application Priority Data
Sep. 7, 2007 (CN) 200720056724.3

(51) Int. Cl. E06C 7/04

(52) U.S. Cl. 182/209

(57) ABSTRACT

An extendable and retractable ladder which comprises a plurality of ladder sections, each of which is stackable upon and nestable within the adjacent ladder section. A locking means is disposed between adjacent ladder sections to lock relative installation positions of the ladder sections. The locking means is disposed in a middle portion of the rung of the ladder section and it comprises a left and a right locking rods which move in synchrony with each other, a spring which connects the left and the right locking rods, and a left and a right controlling handles which are connected to the left and the right locking rods respectively. Locking holes are disposed on adjacent ladder sections and free ends of the left and the right locking rods at corresponding positions. As only one single hand is required to simultaneously pull the left and the right controlling handles to unlock the ladder sections, the present invention is more convenient to use.

### BACKGROUND OF THE INVENTION

The present invention relates to a ladder and more particularly pertains to an extendable and retractable ladder which is adjustable in length and collapsible for storage.

Ladders are often used in production and daily life. The length of conventional ladders is not adjustable and so it is very inconvenient to store and carry the ladders. Chinese patent CN2268119Y discloses an extendable and retractable ladder which is divided into three sections of vertical supports. The supports of each section are connected by a rung to form a ladder section. Each of the two ends of the rung is disposed with a spring and a fixing pin. To retract the ladder, the user moves the fixing pins at the two ends of the rung with his left and right hands respectively to sequentially unlock the supports of adjacent ladder sections. Then, the upper ladder section is retracted into the lower ladder section with the help from an external force or other people. Extendable and retractable ladders of this kind of construction are inconvenient to use as the cooperation of a group of people is required for the extension or retraction of the ladders.

### BRIEF SUMMARY OF THE INVENTION

In view of the aforesaid disadvantages now present in the prior art, the object of the present invention is to provide a new extendable and retractable ladder which can be extended and retracted by the control of one single hand and is safer to use.

To attain this, the present invention generally comprises a plurality of ladder sections, each of which is stackable upon and nestable within the adjacent ladder section. Each ladder section comprises two vertical pillars, one on a left side thereof and one on a right side thereof, and a rung connecting the vertical pillars. A locking means is disposed between adjacent ladder sections to lock relative installation positions of the ladder sections. The locking means is disposed in a middle portion of the rung of the ladder section and it comprises a left and a right locking rods which move in synchrony with each other, a spring which connects the left and the right locking rods, and a left and a right controlling handles which are connected to the left and the right locking rods respectively. Locking holes are disposed on adjacent ladder sections and free ends of the left and the right locking rods at corresponding positions.

The rung is a H-shaped pipe with an inner tube disposed therein. The left and the right locking rods and the spring are disposed in the inner tube. The wall of the inner tube is disposed with elongated openings which allow the protrusion and horizontal movement of the corresponding controlling handles.

The controlling handles are each disposed with a groove at opposing ends thereof. The grooves are each pivotally disposed with a movable clasp which is pivotable about a pivot axis for at least 90 degrees.

The grooves are horizontally disposed and extend along the outer sides of the controlling handles.

The movable clasps are L-shaped. One end of the L-shaped movable clasp is pivotally connected to the controlling handle and an other end thereof can fasten onto the outer side of the controlling handles after the movable clasp has rotated around the pivot axis for 90 degrees.

When the left and the right locking rods insert into the corresponding locking holes, the left and the right movable clasps are parallel to the rung, and the distance between the opposite ends of the left and the right movable clasps is zero or less than the distance of movement of the left and the right locking rods.

To use the present invention, first rotate the two movable clasps until they are parallel to the rung and the ends of the movable clasps are opposite each other. As a result, the left and the right locking rods cannot move towards the centre by external force and the locking status of the ladder sections can be maintained. To retract the present invention, rotate the movable clasps outwards to fasten them onto the controlling handles, at the same time move the left and the right controlling handles to sequentially retract the present invention. If the invention is an A-shaped ladder, the user can first unlock the ladder sections on the left and then retract the ladder sections on the left, then unlock the corresponding ladder sections on the right and then retract the ladder sections on the right.

As an improvement for the present invention, the bottom of the ladder legs of the present invention are each disposed with a pad. The pads are connected to the left and the right vertical pillars of the lowest ladder section of the ladder leg respectively by an angle adjusting means.

The present invention has the following advantages: the controlling part of the locking means of the present invention is disposed in a middle portion of the rung and connected by a spring, therefore only one single hand is required to simultaneously pull the left and the right controlling handles to unlock the ladder sections. This is more convenient in comparison with the conventional construction. More particularly, the present invention is additionally disposed with a safety means (movable clasps) at the left and the right controlling handles. The movable clasps can prevent accidents caused by the retraction of the present invention due to accidental movement of the controlling handles or the malfunction of the spring, thereby increasing the safety of the present invention. Moreover, the pads of the present invention are disposed with angle adjusting means. Therefore, when the present invention is used in an inclined position, its slip-proof pads remain in contact with the ground which greatly increases the stability and safety of using the present invention.

### BRIEF DESCRIPTION OF THE DRAWINGS

FIG. 1 is a front view of the extendable and retractable ladder of the present invention.

FIG. 2 is a cross-sectional view along line A-A in FIG. 1.

FIG. 3 is an enlarged view of the area B in FIG. 2.

FIG. 4 is a perspective view of FIG. 1

FIG. 5 is an enlarged view of the area C in FIG. 4.

FIG. 6 is an enlarged view of the area D in FIG. 4.

FIG. 7 is a perspective view of the present invention as in FIG. 4 after being retracted.

FIG. 8 is a top view of FIG. 7

FIG. 9 is an enlarged view of the area E in FIG. 8

FIG. 10 is a perspective view showing the connection of the pad of the present invention with a vertical pillar.

FIG. 11 is a perspective view of FIG. 10 with parts removed.

FIG. 12 is a partial cross-sectional view of FIG. 10.

FIG. 13 is a partial cross-sectional view of FIG. 10 in an alternative direction.

FIG. 14 is an axonometric view of FIG. 10.

### DETAILED DESCRIPTION OF THE INVENTION

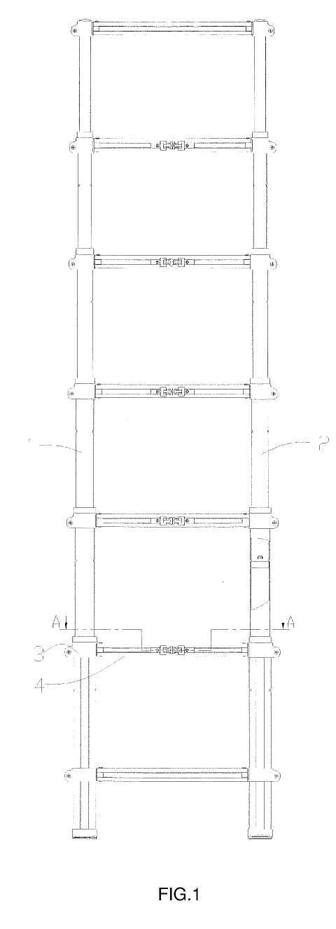

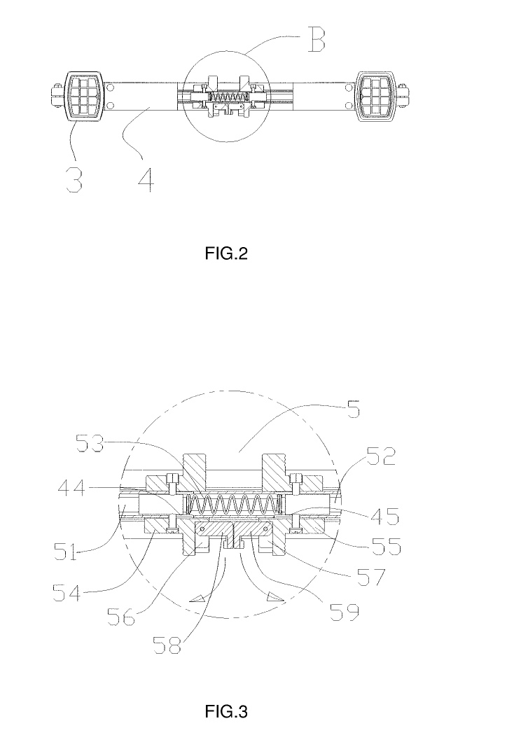

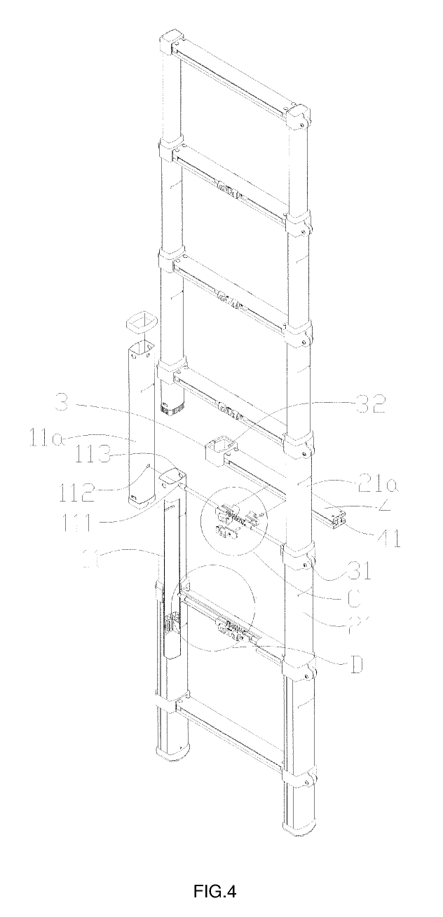

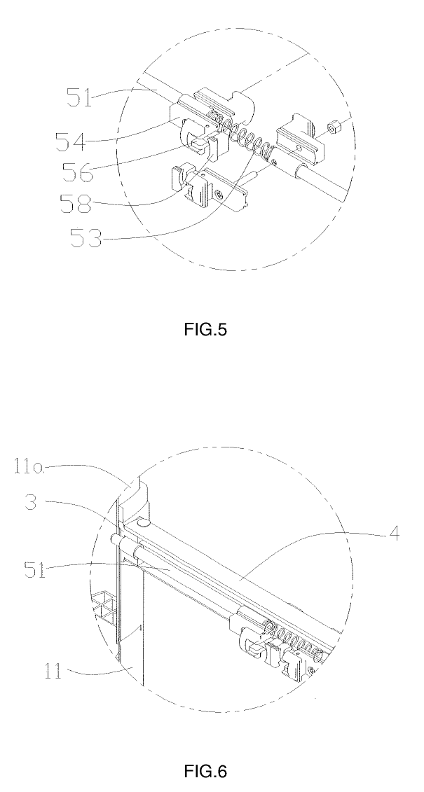

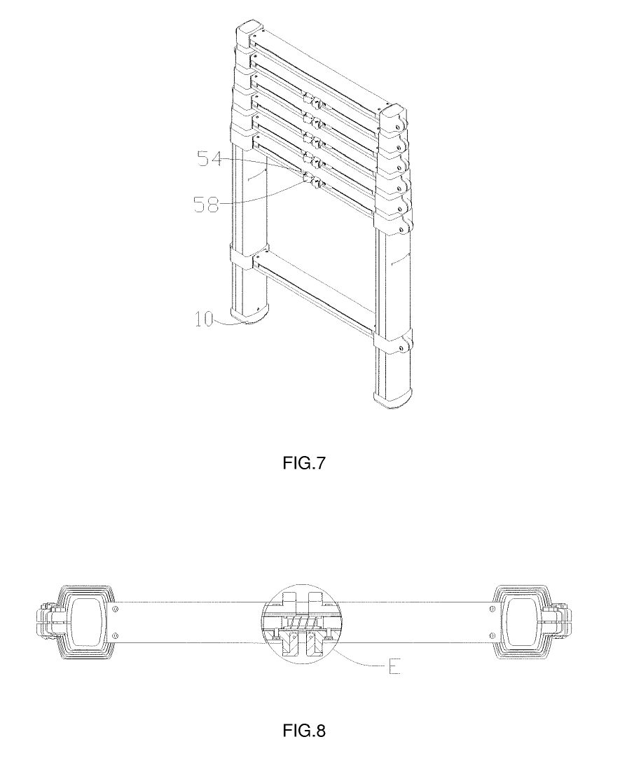

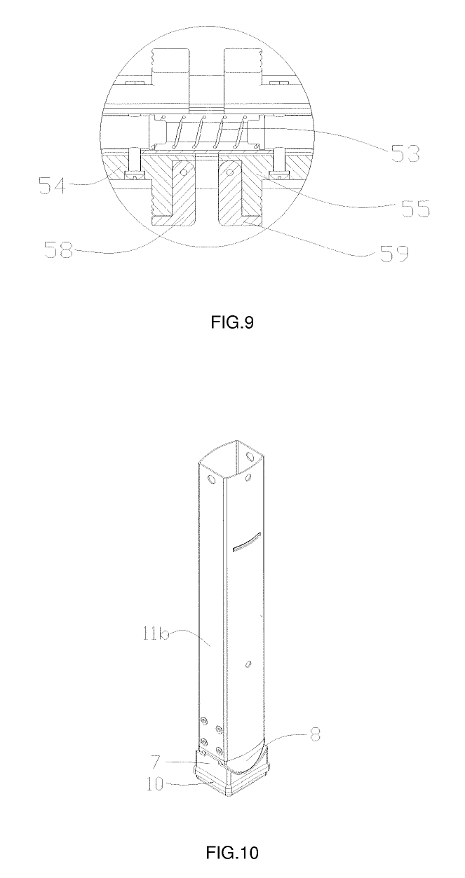

As illustrated in FIGS. 1 to 9, this embodiment is an I-shaped extendable and retractable ladder which comprises six ladder sections, each of which is stackable upon and nestable within the adjacent ladder section. Each ladder section comprises a left and a right vertical pillars 11, 12 and a rung 4 connecting the left and the right vertical pillars 11, 12. A left ladder leg 1 is constituted by the left vertical pillars of all the six ladder sections, each of which is stackable upon and nestable within the adjacent left vertical pillar, and a right ladder leg 2 is constituted by the right vertical pillar of all the six ladder sections, each of which is stackable upon and nestable within the adjacent right vertical pillar. The rung 4 of each ladder section is disposed with a locking means 5 in a middle portion thereof for simultaneous locking of the adjacent vertical pillars 11, 11a on the left and the adjacent vertical pillars 21, 21a on the right. The rung 4 is a H-shaped pipe with an inner tube 41 disposed therein (as shown in FIG. 4). A left locking rod 51, a right locking rod 52 and a spring 53 are disposed in the inner tube 41 of the rung 4. The left locking rod 51 and the right locking rod 52 are connected by the spring 53 to each other at opposing ends thereof. The adjacent stackable and nestable left vertical pillars 11, 11a on the left are each disposed with a locking hole 111, 112. When the extendable and retractable ladder is being extended, the locking holes 111, 112 overlap each other and the free end of the left locking rod 51 inserts into the locking holes 111, 112, thereby locking the relative positions of the left vertical pillars 11, 11a of the two adjacent ladder sections. Similarly, the adjacent stackable and nestable vertical pillars 21, 21a on the right of the extendable and retractable ladder are interlocked by the right locking rod 52 through the same means. The ends of the left and right locking rods 51, 52 which are connected to the spring 53 are each fixedly engaged with a L-shaped controlling handle 54, 55 by a screw (for the sake of easy operation, both the front and the rear sides of the rung 4 can be disposed with controlling handles, as shown in FIGS. 3 and 4). The wall of the inner tube 41 of the rung 4 is disposed with elongated openings 44, 45 (as shown in FIG. 3) so as to allow the screws connected with the controlling handles 54, 55 to penetrate the wall of the inner tube 41 to connect with the left locking rod 51 and the right locking rod 52 respectively. The inner tube 41 and the elongated openings 44, 45 confine the path and the distance of movement of the controlling handles 54, 55.

The free ends of the left and the right locking rods 51, 52 are driven by the same spring 53 to simultaneously insert into the corresponding locking holes to lock the vertical pillars on the two sides, and the spring 53 and the controlling handles 54, 55 for controlling the left and the right locking rods 51, 52 are disposed in the middle portion of the rung 4 As a result, to retract the ladder, user may use only one single hand to simultaneously control the two controlling handles 54, 55, thereby simultaneously moving the left locking rod 51 and the right locking rod 52 so as to allow smooth retraction of the extendable and retractable ladder.

This embodiment is further improved on the above basis. The two controlling handles 54, 55 are each disposed with a groove 56, 57 at opposing ends thereof. The grooves 56, 57 are horizontally disposed and extend along the outer sides of the controlling handles 54, 55. The grooves 56, 57 are each pivotally disposed with a movable clasp 58, 59 which is pivotable about a pivot axis for at least 90 degrees in a fixed direction. The movable clasp 58 is L-shaped. One end of the L-shaped movable clasp 58 functions as a rotational arm and is pivotally connected to the controlling handle 54. The end of the movable clasp 58 is curved. After the movable clasp 58 has rotated around the pivot axis for 90 degrees, the other end of the movable clasp 58 can fasten onto the outer surface of the controlling handle 54. Moreover, when the left and the right locking rods 51, 52 insert into the corresponding locking holes, the left and the right movable clasps 58,59 are parallel to the rung 4, and the distance between the opposite ends of the left and the right movable clasps 58, 59 is zero. When the left and the right locking rods 51, 52 are in the locking status, the opposite ends of the left and the right movable clasps 58, 59 abut against each other to ensure that the controlling handles 54, 55 will not move accidentally. To retract the ladder, first rotate the left and the right movable clasps 58, 59 towards the outer sides of the rung 4 respectively, the shorter ends of the L-shaped movable clasps 58, 59 are then fastened onto the outer surfaces of the left and the right controlling handles 54, 55 respectively. Then, simultaneously move the controlling handles 54, 55 towards the middle of the rung 4. The shape of the left and the right movable clasps 58, 59 is not limited to that as shown in the accompanying drawings and the rotation direction is not limited to horizontal. The movable clasps 58, 59 can prevent accidents caused by the retraction of the ladder due to accidental movement of the controlling handles 54, 55 or the malfunction of the spring 53.

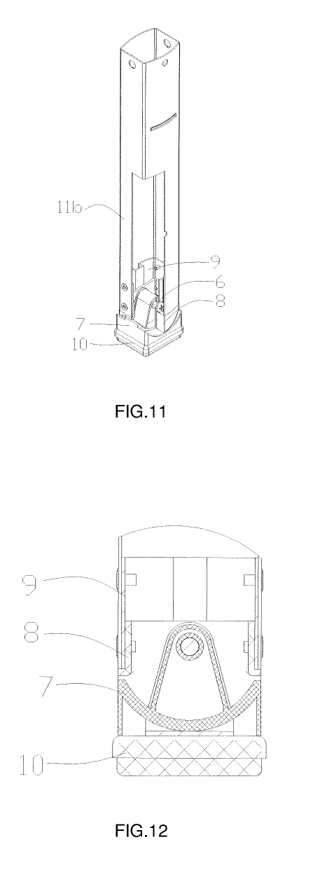

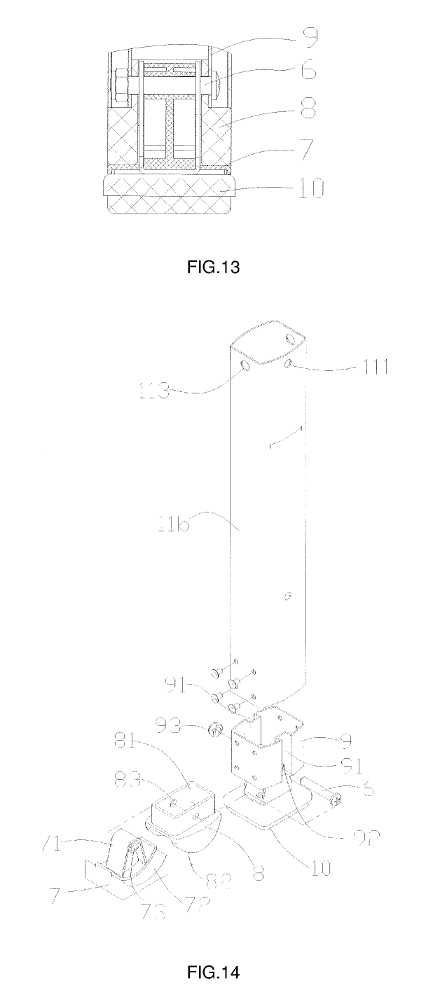

This embodiment is further improved in another aspect. The bottom of the left ladder leg 1 and the right ladder leg 2 of the extendable and retractable ladder are each disposed with a pad 10. As illustrated in FIGS. 10 to 14, the pad 10 is connected to the vertical pillar 11b of the lowest ladder section of the ladder leg of the extendable and retractable ladder by an angle adjusting means. The angle adjusting means comprises a depressed sliding track 7 and a curved swinging piece 8 corresponding thereto which are pivotable relative to each other about a pin 6. The depressed sliding track 7 is affixed to the upper part of the pad 10 and the curved swinging piece 8 is affixed to the lower part of the vertical pillar 11b. The depressed sliding track 7 is disposed with a mounting platform 71 in a middle portion thereof. Two sides of the mounting platform 71 are each disposed with an inwardly curved surface 72 parallel to each other. The mounting platform 71 is disposed with mounting holes 73 for receiving the pin 6. The curved swinging piece 8 is disposed with a cavity 81 in a middle portion thereof for receiving the mounting platform 71 of the depressed sliding track 7. Two sides of the curved swinging piece 8 are each disposed with a curved projection 82 which corresponds to the inwardly curved surfaces 72 of the depressed sliding track 7. The walls of the cavity 81 are also disposed with mounting holes 83 for receiving the pin 6. The depressed sliding track 7 and the curved swinging piece 8 are pivotable relative to each other about the pin 6, and the curved swinging piece 8 swings along the inwardly curved surfaces 72 of the depressed sliding track 7. A sleeve 9 is disposed between the vertical pillar 11b and the curved swinging piece 8. The dimension of the sleeve 9 corresponds to that of the inner wall of the vertical pillar 11b. Two sides of the sleeve 9 are respectively disposed with a recess 91. The wall of the recess 91 is disposed with a mounting hole 92. The head of the pin 6 which pivotally connects the depressed sliding track 7 and the depressed swinging piece 8 together with a fixing bolt cap 93 is received within the recess 91 to prevent any collision between the sleeve 9 and the vertical pillar 11b during assembly. The sleeve 9 is fixedly engaged with the vertical pillar 11b by screws or rivets.

In addition, as shown in FIGS. 4, 6 to 8, the rung 4 is engaged with the left and the right vertical pillars 11, 21 by fastening pieces 3 and fixed in position by fixing screws. One end of the fastening piece 3 is a C-shaped clamp 31 with an internal dimension corresponding to the dimension of the cross section of the left vertical pillar 11. The inner side of the C-shaped clamp 31 is disposed with a positioning circular platform 32 (as shown in FIG. 4), and a circular hole 113 is disposed on the upper part of the left vertical pillar 11 at a position corresponding to the positioning circular platform 32. When the circular platform 32 is engaged with the circular hole 113, the rung 4 and the left vertical pillar 11 are connected as a whole by fixing the opening of the C-shaped clamp 31 by means of fixing screws. The connection of other rungs and vertical pillars are likewise. In this way, the majority of the weight of the user standing on the rung 4 is transferred to the corresponding left vertical pillar 11 and right vertical pillar 21 by the fastening pieces 3 instead of focusing entirely on the left and the right locking rods 51, 52. As a result, the extendable and retractable ladder has a longer lifespan and is more durable.

The above improvements in the construction of this embodiment can also be applied to extendable and retractable A-shaped ladder.

What is claimed is:

1. An extendable and retractable ladder which comprises a plurality of ladder sections, each of which is stackable upon and nestable within the adjacent ladder section; each ladder section comprises two vertical pillars (11, 21), one on a left side thereof and one on a right side thereof, and a rung (4) connecting the vertical pillars (11, 21); a locking means (5) is disposed between adjacent ladder sections to lock relative installation positions of the ladder sections, wherein the locking means (5) is disposed in a middle portion of the rung (4) of the ladder section and it comprises a left and a right locking rods (51, 52) which move in synchrony with each other, a spring (53) which connects the left and the right locking rods (51, 52), and a left and a right controlling handles (53, 54) which are connected to the left and the right locking rods (51, 52) respectively; locking holes are disposed on adjacent ladder sections and free ends of the left and the right locking rods (51, 52) at corresponding positions.

2. The extendable and retractable ladder as in claim 1, wherein the rung (4) is a H-shaped pipe with an inner tube (41) disposed therein; the left and the right locking rods (51, 52) and the spring (53) are disposed in the inner tube (41); the inner tube (41) has a wall disposed with elongated openings (44, 45) which allow protrusion and horizontal movement of the corresponding controlling handles (53, 54).

3. The extendable and retractable ladder as in claim 2, wherein the controlling handles (53, 54) are each disposed with a groove (56, 57) at opposing ends thereof; the grooves (56, 57) are each pivotally disposed with a movable clasp (58, 59) which is pivotable about a pivot axis for at least 90 degrees.

4. The extendable and retractable ladder as in claim 3, wherein the grooves are horizontally disposed and extend along outer sides of the controlling handles.

5. The extendable and retractable ladder as in claim 4, wherein the movable clasps (58, 59) are L-shaped; one end of the L-shaped movable clasp is pivotally connected to the controlling handle and an other end thereof can fasten onto the outer side of the controlling handle after the movable clasp has rotated around the pivot axis for 90 degrees.

6. The extendable and retractable ladder as in claim 3, wherein when the left and the right locking rods insert into the corresponding locking holes, the left and the right movable clasps are parallel to the rung, and the distance between the opposite ends of the left and the right movable clasps is zero or less than the distance of movement of the left and the right locking rods.

7. The extendable and retractable ladder as in any of the claims 1 to 3, wherein the ladder legs of the present invention are each disposed with a pad at a bottom thereof; the pads are each connected to the left and the right vertical pillars of the lowest ladder section of the ladder leg by an angle adjusting means.

8. The extendable and retractable ladder as in claim 7, wherein the angle adjusting means comprises a depressed sliding track (7) and a curved swinging piece (8) corresponding thereto which are pivotable relative to each other about a pin (6); the depressed sliding track (7) is affixed to an upper part of the pad (10) and the curved swinging piece (8) is affixed to a lower part of the vertical pillar (11b).

9. The extendable and retractable ladder as in claim 8, wherein a sleeve (9) is disposed between the vertical pillar (11b) and the curved swinging piece (8); the pin (6) which pivotally connects the depressed sliding track (7) and the depressed swinging piece (8) is received within mounting holes disposed on the sleeve (9) and fixed on the sleeve (9); the sleeve (9) is received within the vertical pillar (11b) and fixedly engaged with the vertical pillar (11b) by fastening means.

10. The extendable and retractable ladder as in claim 7, wherein the extendable and retractable ladder is an I-shaped or A-shaped extendable and retractable ladder.
